(19) United States
(12) Patent Application Publication
(10) Pub. No.: US 2010/0180613 A1
(43) Pub. Date: Jul. 22, 2010

(54) EXPANSION VALVE

(76) Inventors: Hiromi Takasaki, Saitama (JP); Toshisada Kujirai, Saitama (JP); Fuminori Ooba, Saitama (JP); Takayuki Kume, Saitama (JP); Enhua Bian, Saitama (JP)

Correspondence Address: WENDEROTH, LIND & PONACK, L.L.P., 1030 15th Street, N.W.,, Suite 400 East, Washington, DC, 20005-1503, US

(21) Appl. No.: 12/448,917

(22) PCT Filed: Jan. 15, 2008
(86) PCT No.: PCT/JP2008/050322

§ 371 Date: Feb. 23, 2010

(30) Foreign Application Priority Data
Jan. 16, 2007 (JP) 2007-007337

(51) Int. Cl. F25B 41/06; F25B 49/02; F16K 31/68

(52) U.S. Cl. 62/225; 251/11

(57) ABSTRACT

An expansion valve having a tubular member (15) for receiving a low-pressure refrigerant (14) sent from an evaporator (13) and also having a tube member (16) inserted in the tubular member (15) and receiving a high-pressure refrigerant sent from a condenser (12). The expansion valve has a valve mechanism (17) provided in the tube member (16). An end wall (18) is formed at one end (15a) of the tubular member (15), and the end wall (18) has a low-pressure inflow hole (19) for allowing the refrigerant (14) sent from the evaporator (13) to flow into the tubular member (15) and a high-pressure outflow hole (20) for allowing the refrigerant (14) to flow out from the tube member (16) into the evaporator (13). A lid member (28) is detachably attached to the other end (15b) of the tubular member (15), and the lid member (28) has a low-pressure outflow hole (35) for allowing the refrigerant (14) to flow out from the inside of the tubular member (15) and a high-pressure inflow hole (36) for allowing the refrigerant (14) sent from the condenser (12) to flow into the tube member (16) inserted in the tubular member (15).

### TECHNICAL FIELD

The present invention relates to an expansion valve that controls an inflow quantity of a refrigerant from a condenser to an evaporator in accordance with a temperature of the refrigerant that is conveyed from the evaporator, in which the expansion valve is installed upon an air conditioning apparatus that is built into a vehicle, as an instance.

### BACKGROUND ART

Conventionally, an expansion valve is incorporated upon an air conditioning apparatus that is installed upon a vehicle, as an instance, wherein the expansion valve expands a refrigerant in a high-temperature, high-pressure state, which has been compressed by a compressor and liquefied by a condenser; refer, as an instance, to Patent literature 1. The refrigerant is expanded by the expansion valve into a low-temperature, low-pressure state, and thereafter flows from the expansion valve and into an evaporator, to be gasified thereupon by the evaporator, using a heat absorbed from an air within a passenger compartment of the vehicle, whereupon the refrigerant is returned to the compressor from the evaporator. Such an expansion valve comprises a valve mechanism that adjusts an inflow quantity of the refrigerant from the condenser to the evaporator, in accordance with the temperature of the refrigerant that is conveyed from the evaporator, and a block body that houses the valve mechanism.

A high-pressure flow path, which is connected to an inflow aperture of the evaporator, and a low-pressure flow path, which is connected to an outflow aperture of the evaporator, is formed upon the block body so as to be mutually approximately parallel respectively, and to mutually respectively pass through the block body. In addition, a housing aperture, wherethrough the valve mechanism is inserted, is formed upon the block body, so as to be respectively orthogonal to each respective flow path, and to pass through a partition, which isolates the high-pressure flow path from the low-pressure flow path. The housing aperture is open toward an upper portion of the block body, and the valve mechanism is housed within the block body by being inserted within the housing aperture from the upper portion of the block body.

The valve mechanism comprises a diaphragm, which is a displacement member that displaces in accordance with the temperature of the refrigerant, a diaphragm that is positioned within the low pressure fluid path, senses the temperature of the refrigerant that flows upon the low-pressure flow path, and displaces in accordance with the temperature thereof, a valve body, which is positioned within the high-pressure flow path and moves by displacement of the diaphragm thereupon, and a valve seat that receives the valve body thereupon in order to close the high-pressure flow path.

With regard to the conventional valve mechanism described herein, as an instance thereof, when the temperature of the refrigerant flowing within the low-pressure flow path from the evaporator is low, a pressure within the temperature sensing part decreases, due to the temperature decreasing within the temperature sensing part, such that the diaphragm is displaced in an upward direction. As a consequence of the displacement of the diaphragm in the upward direction thereupon, the valve body is moved toward the valve seat, and, as a further consequence thereof, an interstice between the valve body and the valve seat, that is, a degree of opening of the valve, is reduced. As a result, a surface area whereupon the flow within the high-pressure flow path is possible is reduced, such that the refrigerant flowing from the condenser within the high-pressure flow path is expanded, and it will be possible thereby to reduce the inflow quantity of the refrigerant that is caused to flow upon the evaporator.

### Citation List

Patent Literature
JP-H06-272999-A

### SUMMARY OF INVENTION

### Technical Problem

Given, however, with regard to the conventional expansion valve such as is described herein, that the high-pressure flow path, the low-pressure flow path, and the housing aperture, are respectively formed into a unified block body, it is necessary to adjust, with a high precision and in accordance with the state of the valve mechanism, a relative location of a formation of the high-pressure flow path, the low-pressure flow path, and the housing aperture upon the block body, in order for the diaphragm of the valve mechanism to be reliably positioned upon the low-pressure flow path, and in order for the valve seat and the valve body to be reliably positioned respectively upon the high-pressure flow path. Accordingly, a problem arises wherein a processing operation upon the block body is made increasingly complex, and as a result of the increasing complexity thereof, a manufacturing of the expansion valve involves much time and effort.

It is an objective of the present invention to provide an expansion valve that can be easily manufactured, regardless of the state of the valve mechanism.

### Solution to Problem

In order to achieve the objective described herein, an expansion valve according to an embodiment of the present invention is configured to control an inflow quantity of a refrigerant that is conveyed, from a condenser that liquefies the refrigerant, to an evaporator, which is for gasifying the liquid refrigerant, in accordance with a temperature of the refrigerant when being conveyed from the evaporator, after being thus gasified, toward a gas compressor that compresses the refrigerant thus gasified by the evaporator. The expansion valve comprises a tubular member, which is for taking in a low-pressure refrigerant that is conveyed thereupon from the evaporator, a pipe member, which is inserted within the tubular member, and which receives a high-pressure refrigerant conveyed thereupon from the condenser, and a valve mechanism, which is installed upon the pipe member, and which operates so as to adjust a circulation quantity of the refrigerant within the pipe member. The valve mechanism further comprises a displacement member, which is positioned external to the pipe member, and which displaces in accordance with a temperature of the refrigerant passing through the tubular member, a valve body, which is positioned within the pipe member, and which moves by a displacement of the displacement member, and a valve seat, which is positioned within the pipe member, and which receives the valve body, in order to close the pipe member. An end partition is formed upon one end of the tubular member, which closes the end thereof, a lid member is detachably attached upon another end of the tubular member, which closes the another end thereof, a low-pressure inflow aperture, which is for causing the refrigerant that is conveyed from the evaporator to flow within the tubular member, and a high-pressure outflow aperture, which is for causing the refrigerant to flow out from the pipe member, which is inserted within the tubular member, and therefrom within the evaporator, are formed upon one of the end partition and the lid member, and a low-pressure outflow aperture, which is for causing the refrigerant to flow out from within the tubular member, and a high-pressure inflow aperture, which is for causing the refrigerant that is conveyed from the condenser to flow within the pipe member that is inserted within the tubular member, are formed upon the another of the end wall and the lid member.

### BRIEF DESCRIPTION OF DRAWINGS

FIG. 1 is a longitudinal cross-section view that conceptually depicts an expansion valve according to the present invention.

FIG. 2 is a lateral cross-section view that conceptually depicts the expansion valve according to the present invention.

FIG. 3A is an elevation view that conceptually depicts an embodiment of a projection part according to the present invention.

FIG. 3B is an elevation view that conceptually depicts another embodiment of the projection part according to the present invention.

FIG. 3C is an elevation view that conceptually depicts another embodiment of the projection part according to the present invention.

FIG. 4 is a longitudinal cross-section view that conceptually depicts an expansion valve according to an embodiment other than the embodiment that is depicted in FIG. 1.

### DESCRIPTION OF EMBODIMENTS

The best mode for carrying out the present invention will be described in detail hereinafter, based upon a specific embodiment thereof, and with reference to the attached drawings.

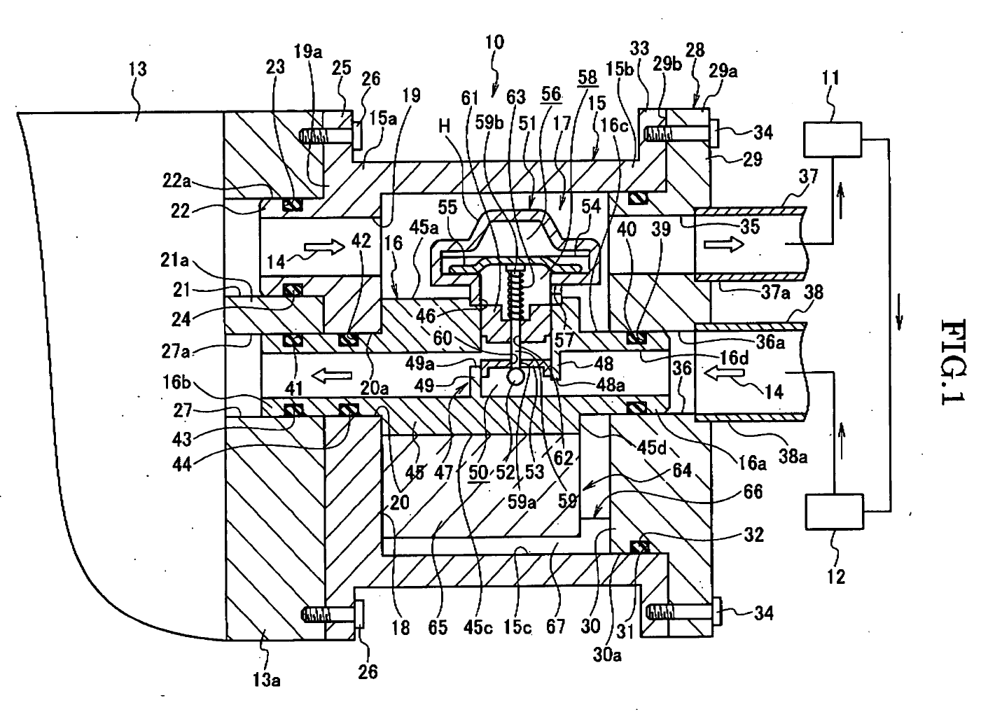

FIG. 1 depicts an embodiment of an expansion valve 10 according to the present invention, in which the expansion valve 10 is applied to an air conditioning apparatus, which in turn is installed upon a vehicle (not shown). The expansion valve 10 is configured so as to cause a refrigerant 14, which is compressed by a gas compressor 11 and liquefied by a condenser 12 into a state of high temperature and pressure, to expand, thereby forming the refrigerant into a state of low temperature and pressure, and thereby to cause the refrigerant thus formed into the state of low temperature and pressure to flow within an evaporator 13.

The expansion valve 10 according to the present invention, such as is depicted in FIG. 1, comprises a tubular member 15, which is for taking in a low pressure refrigerant 14 that is conveyed thereupon from the evaporator 13, a pipe member 16, which is inserted within the tubular member and which takes in a high-pressure refrigerant 14 that is conveyed thereupon from the condenser 12, and a valve mechanism 17, which is installed upon the pipe member, and which operates so as to adjust a circulation quantity of the refrigerant 14 within the pipe member.

The tubular member 15, as depicted in FIG. 1, is configured from a cylindrical member, and is positioned such that an axis thereof is aligned in a horizontal direction, i.e., a left and right direction, as viewed in FIG. 1, with regard to a vertical direction of the vehicle, i.e., an up and down direction, as viewed in FIG. 1.

An end partition 18 is formed upon one end 15a of the tubular member 15, which closes the one end thereof. As depicted in FIG. 1, a low-pressure inflow aperture 19, which is for causing the low-pressure refrigerant 14, which is conveyed from the evaporator 13, to flow within the tubular member 15, and a high-pressure outflow aperture 20, which is for causing the high-pressure refrigerant 14 to flow out from within the pipe member 16, which is inserted within the tubular member 15, to the evaporator 13, are formed upon the end partition 18.

As depicted in FIG. 1, a pipe part 22 is formed upon an edge part 19a of the low pressure inflow aperture 19, wherein the pipe part 22 is positioned so as to protrude from the edge part toward the evaporator 13, external to the direction of the axis of the tubular member 15, in order to encompass the low-pressure inflow aperture 19, and to be fitted onto a discharge aperture 21, which is formed upon a peripheral wall 13a of the evaporator 13. The discharge aperture 21 of the evaporator 13, as is conventionally known and established, is an aperture for externally discharging the refrigerant 14, which has been gasified within the evaporator 13 with a heat, which in turn is absorbed from an air within a passenger compartment, from the evaporator 13. Given that the pipe part 22 is fitted upon the discharge aperture 21, it becomes possible for the refrigerant 14 that is discharged from the discharge aperture 21 of the evaporator 13 to flow within the tubular member 15, by way of the low-pressure inflow aperture 19 and the pipe part 22. A depression 23, which extends in a direction of a circumference of the pipe part 22, is formed upon an external circumference surface 22a of the pipe part 22, and a ring-shaped seal member 24 is installed such that an airtight seal is formed upon an interval between the external circumference surface 22a of the pipe part 22 and a circumference surface 21a of the discharge aperture 21. As a result, when the refrigerant 14 flows within the pipe part 22 from the discharge aperture 21 of the evaporator 13, a leakage of the refrigerant 14 external to the pipe part 22, by way of the interval between the external circumference surface 22a of the pipe part 22 and the circumference surface 21a of the discharge aperture 21, is prevented.

In addition, a ring-shaped first flange part 25, which is anchored upon a peripheral wall 13a of the evaporator 13, is formed upon the one end 15a of the tubular member 15, so as to protrude externally upon a direction of a diameter of the tubular member 15 from the one end thereof, and to extend upon the direction of the circumference of the tubular member 15. The first flange part 25, as depicted in FIG. 1, is anchored by a bolt member 26 upon the peripheral wall 13a of the evaporator 13. The anchoring thereof of the first flange part 25 upon the peripheral wall 13a of the evaporator 13 is such that the tubular member 15 is anchored upon the evaporator 23 in a state wherein the pipe part 22 is fitted upon the discharge aperture 21.

The high-pressure outflow aperture 20 is formed upon the end partition 18, so as to conform to an intake aperture 27 of the evaporator 13 in a state wherein the tubular member 15 is mounted upon the evaporator 13, and the high-pressure outflow aperture 20 is further formed upon the end partition 18, leaving an interval below the low pressure inflow aperture 19, such as is depicted in FIG. 1. The intake aperture 27 of the evaporator 13 is formed upon the peripheral wall 13a of the evaporator 13 below the discharge aperture 21, and, as is conventionally known and established, the intake aperture 27 is an aperture for taking in the refrigerant 14, which is conveyed thereto from the condenser 12, by way of the expansion valve 10.

A lid member 28 that closes the another end 15b of the tubular member 15 is attached detachably at the another end thereof.

As depicted in FIG. 1, the lid member 28 comprises an approximately disc shaped disc part 29, which is positioned upon an edge surface of the another end 15b of the tubular member 15 such that a fringe part 29a of the disc shaped disc part 29 protrudes external to the direction of the diameter of the tubular member 15, and a cylindrical tube shaped fitting part 30, which is fitted upon the another end 15b of the tubular member 15, and protrudes from a surface 29b, which in turn is positioned upon a side of the tubular member 15 of the disc part.

A depression part 31, which extends upon a direction of a circumference of the fitting part 30, is formed upon the external peripheral surface 30a of the fitting part 30, and a ring-shaped seal member 32 is installed within the depression part, so as to seal, in an airtight manner, an interval between the external peripheral surface 30a of the fitting part 30 and an internal peripheral surface 15c of the tubular member 15. As a result, a leakage of the refrigerant 14 within the tubular member 15 external to the tubular member 15, by way of the interval between the internal peripheral surface 15c of the tubular member 15 and the external peripheral surface 30a of the fitting part 30, is prevented.

According to the embodiment depicted in FIG. 1, a second circular flange part 33 is formed upon the another end 15b of the tubular member 15, so as to protrude from the another end thereof external to the direction of the diameter of the tubular member 15, and to extend upon the direction of the circumference of the tubular member 15. The fringe part 29a of the disc part 29 of the lid member 28 comes into contact with the second flange part 33, with the fitting part 30 in a fitted state upon the another end 15b of the tubular member 15, and is further anchored upon the flange part, in a state of coming into contact with the flange part, by a bolt member 34. By way of the fringe part 29a of the disc part 29 being anchored upon the second flange part 33, the lid member 28 is anchored upon the tubular member 15 by way of the second flange part 33, in a state wherein the fitting section 30 is fitted upon the another end 15b of the tubular member 15.

In addition, as depicted in FIG. 1, a low-pressure outflow aperture 35, which is for allowing the low-pressure refrigerant 14 to flow out from within the tubular member 15 upon the gas compressor 11, and a high-pressure inflow aperture 36, which is for allowing the high-pressure refrigerant 14, which is conveyed thereupon from the condenser 12, to flow in turn within the pipe member 16, which is further inserted upon the tubular member 15, are formed upon the lid member 28, in order to respectively pass through the fitting part 30 and the disc part 29. As depicted in FIG. 1, the low-pressure outflow aperture 35 and the high-pressure inflow aperture 36 are formed upon the fitting part 30 of the lid member 28, upon a location thereof respectively facing the low-pressure inflow aperture 19 and the high-pressure outflow aperture 20.

An edge part 37a of a connecting pipe 37 is fitted upon the low pressure outflow aperture 35, in order to mutually connect the gas compressor 11 and the expansion valve 10. The low temperature and pressure refrigerant 14, having flowed within the tubular member 15 from the evaporator 13, by way of the low-pressure inflow aperture 19, in turn flows within the connecting pipe 37 from within the tubular member 15, by way of the low-pressure outflow aperture 35, and is guided thereafter to the gas compressor 11 through the interior of the connecting pipe.

An edge part 38a of a connecting pipe 38 is fitted upon the high-pressure inflow aperture 36, in order to mutually connect the condenser 12 and the expansion valve 10. The high temperature and pressure refrigerant 14, having been liquefied by the condenser 12, is guided through the connecting pipe 38 upon the expansion valve 10.

As depicted in FIG. 1, the pipe member 16 is configured from a cylindrical member, and is positioned within the tubular member 15, such that a direction of an axis of the pipe member 16 matches a direction of an axis of the tubular member.

The one end part 16a, which is located upon a side of the pipe member 16 that is toward the lid member 28, is fitted upon the high-pressure inflow aperture 36, which in turn is formed upon the lid member 28. By way of the end part 16a of the pipe member 16 being fitted upon the high-pressure inflow aperture 36 thereof, it becomes possible for the refrigerant 14, which is guided from the condenser 12, through the connecting pipe 38, upon the expansion valve 10, to flow thereupon within the pipe member 16, by way of the high pressure inflow aperture 36.

A depression part 39, which extends upon a direction of a circumference of the pipe part 16, is formed upon a part of the one end part 16a of an external peripheral surface 16c of the pipe member 16, and within the depression part thereof, a ring-shaped seal member 40 is installed so as to form an airtight seal upon an interval between the external peripheral surface 16c of the one end part 16a of the pipe member 16 and the peripheral surface 36a of the high-pressure inflow aperture 36. As a result, a leakage of the refrigerant 14, having flowed within the high-pressure inflow aperture 36 from the connecting pipe 38, external to the pipe member 16, by way of the interval between the external peripheral surface 16c of the one end part 16a of the pipe member 16 and the peripheral surface 36a of the high-pressure inflow aperture 36, is prevented.

As depicted in FIG. 1, the another end part 16b, which is located at the side of the tubular member 15 of the pipe member 16 that is toward the end partition 18, passes through the end partition 18 externally thereto from within the tubular member 15, by way of the interior of the high-pressure outflow aperture 20, and protrudes from the end partition 18, externally to the direction of the axis of the tubular member 15. In addition, given that the another end part 16b of the tubular member 16 is fitted upon the intake aperture 27 of the evaporator 13 when the pipe part 22 is fitted upon the discharge aperture 21 of the evaporator 13, it is possible for the refrigerant 14, having flowed within the tubular member 16, to flow within the evaporator 13, by way of the high-pressure outflow aperture 20 and the intake aperture 27.

A depression part 41 and 42, which respectively extend upon a direction of a circumference of the tubular member 16, are formed upon a component with respect to the another end part 16b of the external peripheral surface 16c of the tubular member 16, and upon a component in opposition to the peripheral surface 20a of the high-pressure outflow aperture 20 of the tubular member 16. A ring-shaped seal member 43 and 44 is respectively installed upon each respective depression part 41 and 42, such that an airtight seal is respectively formed upon an interval between the external peripheral surface 16c of the tubular member 16 and the peripheral surface 27a of the intake aperture 27, as well as an interval between the external peripheral surface 16c of the tubular member 16 and the peripheral surface 20a of the high-pressure outflow aperture 20. As a result, a leakage of the refrigerant 14, having flowed within the evaporator 13 from within the tubular member 16, external to the tubular member 16, by way of the interval between the external peripheral surface 16c of the member 16 and the peripheral surface 27a of the intake aperture 27, as well as the interval between the external peripheral surface 16c of the tubular member 16 and the peripheral surface 20a of the high-pressure outflow aperture 20, respectively, is prevented.

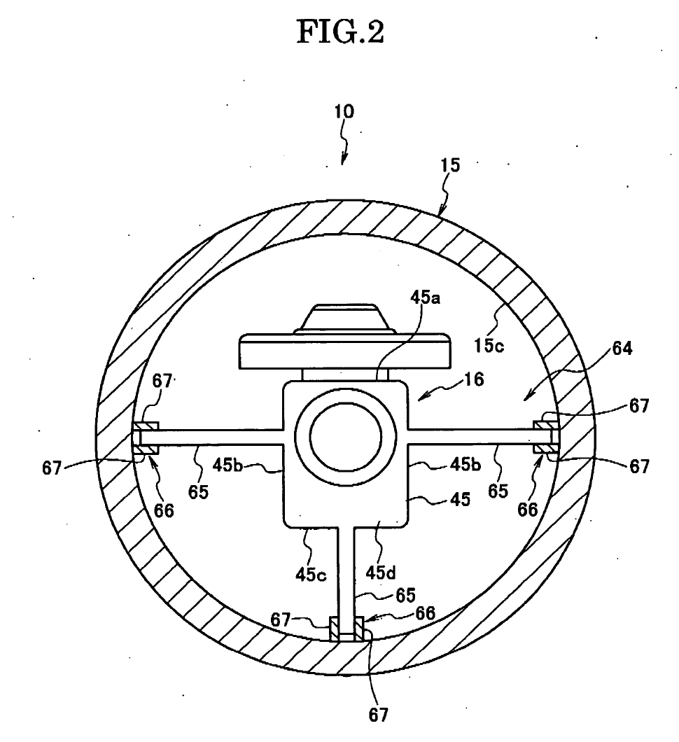

A base part 45, whereupon the valve mechanism 17 is mounted, is formed upon a central part of the pipe member 16, upon the direction of the axis thereof, according to the embodiment depicted in FIG. 1. The base part 45 is formed in approximately a cuboid shape, and is formed upon the central part of the pipe member 16, such that the pipe member 16 passes through an interior part of the base part 45, along a lengthwise direction thereof, such as is depicted in FIG. 1 and FIG. 2. A pass-through aperture 46, which opens upon the interior of the pipe member 16, is formed upon an upper surface 45a of the base part 45, such as is depicted in FIG. 1. The forming thereupon of the pass-through aperture 46 results in the interior part of the pipe member 16, which is positioned within the tubular member 15, and the interior part of the tubular member 15, to mutually communicate by way of the pass-through aperture 46. According to the embodiment depicted in FIG. 1, an interstice is formed between an end surface 45d of the base part 45, the end surface 45d whereof being located on a side of the base part 45 that is toward the lid member 28, and the fitting part 30 of the lid member 28, in the state wherein the pipe member 16 is inserted within the tubular member 15.

According to the embodiment depicted in FIG. 1, a support part 47, which supports a valve seat 53 (to be described hereinafter), is formed upon an interior peripheral surface 16d of the pipe member 16. The support part 47 comprises a pair of disc-shaped support partitions 48 and 49, which are positioned upon both sides of the pass-through aperture 46, upon the direction of the axis of the pipe member 16 thereupon, so as to close the interior of the pipe member 16.

A lower part of the support partition 48, which is the support partition of the pair of support partitions 48 and 49 that is located upon the side toward the end part 16a of the pipe member 16, is removed, and, as a result, an interstice is formed between a lower end 48a of the support partition 48 thereof, and the interior peripheral surface 16d of the pipe member 16. As a consequence, a space between each respective support partition 48 and 49 also mutually communicates with a space upon the end part 16a side of the pipe member 16, by way of the one support partition 48. In addition, an upper part of the support partition 48, which is the, other support partition of the pair of support partitions 48 and 49, which is located upon the side toward the end part 16b of the pipe member 16, is removed, and, as a result, an interstice is formed between an upper end 49a of the support partition 49 thereof, and the interior peripheral surface 16d of the pipe member 16. As a consequence, a space between each respective support partition 48 and 49 also mutually communicates with a space upon the other end part 16b side of the pipe member 16, by way of the other support partition 49. A quantity that is removed from each respective support partition 48 and 49 is set such that each respective support partition 48 and 49 mutually overlaps partially with the other respective support partition 48 and 49 thereof, in order that the valve seat 53 is sandwiched between each respective support partition 48 and 49. A valve chamber 50 is formed by each respective support partition 48 and 49, and the interior peripheral surface 16d, within the pipe member 16.

According to the embodiment depicted in FIG. 1, the valve mechanism 17, which is for adjusting a circulation quantity of the refrigerant 14 within the pipe member 16, further comprises a temperature sensor part 51, which is positioned external to the pipe member 16, and which senses a temperature of the refrigerant 14 that flows within the tubular member 15, a valve body 52, which is positioned within the pipe member 16, and which moves in accordance with the temperature that is sensed by the temperature sensor part 51, and the valve seat 53, which is positioned within the pipe member 16, in order to close the interior of the pipe member thereof.

According to the embodiment depicted in FIG. 1, the temperature sensor part 51 comprises a cylindrical-shaped housing H, which is positioned upon the upper surface 45a of the base part 45 of the pipe member 16, encompassing the pass-through aperture 46 thereupon, and further comprising an open end at one end, which opens within the pass-through aperture 46, a thin film-shaped diaphragm 54, which is positioned within the housing, and a support member 55, which supports the diaphragm.

A substance, such as a gas or an adsorption member, comprising a property that is either similar or identical to the refrigerant 14, is enclosed within the housing H.

According to the embodiment depicted in FIG. 1, the diaphragm 54 is formed from a disc member that is formed from a metal, as an instance thereof, and is positioned within the housing H so as to divide the interior of the housing into an upper and a lower part, by bisecting the housing along an axis thereof. Dividing the interior of the housing H with the diaphragm 54 causes the upper part of the housing H to be formed into a temperature sensing chamber 56. The diaphragm 54 displaces a positional location thereof as a result of a change in a temperature and a pressure within the temperature sensing chamber 56, which arises in turn as a result of a change in a temperature of the refrigerant 14 as it passes within the pipe member 16. Put another way, the diaphragm 54 configures a displacement member, which displaces in accordance with the temperature of the refrigerant 14 as it passes within the pipe member 16. An aperture opening 57, which opens upon the interior of the tubular member 15, is formed upon the lower part of the housing H, and, as a result thereof, a lower space 58 within the housing H, which is below the diaphragm 54 therein, and the interior of the tubular member 15 mutually communicate by way of the aperture opening 57, thereby mutually equalizing a pressure within the lower space 58 and a pressure within the interior of the tubular member 15.

The support member 55 is installed within the lower space 58 of the housing H, and supports the diaphragm 54 from below. The support member 55 is capable of changing a shape thereof in emulation of the displacement of the diaphragm 54. In the instance depicted in FIG. 1, a dowel-shaped rod 59 is installed upon the support member 55, in order to transmit the displacement of the diaphragm 54 upon the valve body 52.

The rod 59 extends downward from the support member 55, within the lower space 58 of the housing H, and furthermore extends within the pipe member 16, by way of extending through the pass-through aperture 46. The valve body 52 is anchored upon a lower end 59a of the rod 59. When the support member 55 changes shape in accordance with the displacement of the diaphragm 54, the rod 59 moves up and down within the pass-through aperture 46 in accordance with the change of shape of the support member thereupon. As a result, the displacement of the diaphragm 54 is transmitted upon the valve body 52, by way of the support member 55 and the rod 59.

According to the embodiment depicted in FIG. 1, the valve body 52 forms a spherical shape, and is positioned within the valve chamber 50, which is prescribed within the pipe member 16. The valve body 52 moves in a vertical direction within the valve chamber 50, by way of the rod 59.

According to the embodiment depicted in FIG. 1, the valve seat 53 comprises a plate shape overall. In addition, the valve seat 53 is positioned above the valve body 52, within the valve chamber 50, in order to close the interval between each respective support partition 48 and 49, and is further supported by each respective support partition 48 and 49 by being sandwiched therebetween. A valve aperture 60, comprising a size that permits the rod 59 to pass therethrough while preventing the valve body 52 from passing therethrough, is formed upon the valve seat 53. The valve aperture 60 is closed by the valve body 52 coming into contact with a fringe part 60a of the valve aperture 60 from below. As a result, the refrigerant 14, which flows within the valve chamber 50 by way of the interstice between the lower end 48a of the one side support partition 48 and the interior peripheral surface 16d of the pipe member 16, is prevented from passing through the valve aperture 60, and the refrigerant 14 within the valve chamber 50 is prevented from passing through the interstice between the upper end 49a of the other side support partition 49 and the interior peripheral surface 16d of the pipe member 16, and flowing thereby from within the valve chamber 50 upon the other end part 16b side of the pipe member 16.

A closing member 61, which is for closing an interior of the pass-through aperture 46 in an airtight manner, is installed within the interior of the pass-through aperture. The closing of the pass-through aperture 46 by the closing member 61 results in the prevention of the refrigerant 14 within the pipe member 16 from flowing within the lower space 58 of the housing H, by way of the pass-through aperture 46. A pass-through aperture 62, which permits the rod 59 to pass through the closing member 61, is formed upon the closing member 61. Furthermore, a compressed coil spring 63, which applies an impetus upon the rod 59 in a direction whereat the valve body 52 is seated upon the valve seat 53, is installed upon the closing member 61. The compressed coil spring 63 is positioned so as to encircle the rod 59, a one end part of the compressed coil spring 63 is locked upon the closing member 61, and another end part of the compressed coil spring 63 is locked upon an upper end 59b of the rod 59. When the valve body 52 is in a state of being seated upon the valve seat 53, i.e., in a state thereof that is depicted in FIG. 1, the compressed coil spring 63 is in a no load state, wherein a shape thereof is not changed with the compression thereupon.

When the temperature of the refrigerant 14 that within the tubular member 15 flows from the evaporator 13 is low, the temperature within the temperature sensing chamber 56 of the temperature sensor part 51, which is positioned within the tubular member 15, declines, and the pressure within the temperature sensing chamber 56 also declines. As a result, when the diaphragm 54 is in a state of displacing in a downward direction, the diaphragm 54 displaces upward as a result of a negative pressure that is received thereupon from an air within the temperature sensing chamber 56, and thus, when the support member 55 changes shape in an upward direction, the rod 59 is uplifted by the impetus of the compressed coil spring 63 thereupon. As a result, the interstice between the valve body 52 and the valve seat 53, or, put another way, a degree of the opening of the valve, is reduced by the valve body 52 moving toward the valve seat 53, whereupon the refrigerant 14, which flows through the valve aperture 60, passing through the valve body 52 and the valve seat 53, is caused to expand, and a flow quantity of the refrigerant 14 that passes within the valve aperture 60 of the valve seat 53 declines. Accordingly, the flow quantity of the refrigerant 14 that is supplied from within the pipe member 16 to the evaporator 13 is reduced.

Conversely, when the temperature of the refrigerant 14 that flows within the tubular member 15 from the evaporator 13 is high, the temperature within the temperature sensing chamber 56 rises with the heat of the refrigerant 14, which is communicated within the temperature sensing chamber 56 by way of the housing H of the temperature sensor part 51, and the pressure within the temperature sensing chamber 56 also increases. As a result, the diaphragm 54 displaces downward as a result of a pressure that is received thereupon from the air within the temperature sensing chamber 56, and thus, the support member 55 changes shape in a downward direction, and the rod 59, which is anchored upon the support member 55, is depressed by a resistance thereby against the impetus of the compressed coil spring 63 thereupon. As a result, the degree of the opening of the valve is increased, and the flow quantity of the refrigerant 14, which passes through the valve aperture 60, increases. Accordingly, the flow quantity of the refrigerant 14 that is supplied from within the pipe member 16 to the evaporator 13 is increased.

Furthermore, according to the embodiment, a rotation prevention unit 64 is installed between the tubular member 15 and the pipe member 16, in order to prevent the pipe member from rotating upon an axial periphery thereof.

According to the embodiment depicted in FIG. 2, the rotation prevention unit 64 comprises two projection parts 65, which protrude respectively from each respective lateral surface 45b of the base part 45 of the pipe member 16 in a direction of the internal peripheral surface 15c of the tubular member 15 toward a lateral facing of the base part 45, a projection part 65, which protrudes from a lower surface 45c of the base part 45 in a direction of the internal peripheral surface 15c of the tubular member 15 toward a downward portion of the base part 45, and a plurality of coupling parts 66, which are formed upon the internal peripheral surface 15c of the tubular member 15, and which couple with each respective projection part 65 in a state of the pipe member 16 being inserted within the tubular member 15.

According to the embodiment depicted in FIG. 2, each respective projection part 65 comprises a plate shape, which respectively extends along a lengthwise direction of the base part 45, or put another way, along the direction of the axis of the pipe member 16.

Each respective coupling part 66 is positioned upon a location that corresponds to each respective projection part 65, in a state wherein the pipe member 16 is inserted within the tubular member 15, such that the upper surface 45a of the base part 45 faces in an upward direction thereupon, and, according to the embodiment depicted in FIG. 2, comprises a pair of plate parts 67, which protrude from the internal peripheral surface 15c of the tubular member 15, and which extend mutually in parallel along the direction of the axis of the tubular member 15. Each respective plate part 67 is positioned so as to mutually leave an interstice therebetween, in the direction of the circumference of the tubular member 15, and the interstice between each respective plate part 67 of each respective coupling part 66 further comprises a size that accommodates each respective projection part 65 in an interval therebetween. Each respective coupling part 66 fits tightly upon each respective projection part 65, by accommodating each respective projection part thereof between each respective plate part 67 thereupon.

In a state wherein each respective projection part 65 is fitted tightly upon each respective coupling part 66, as described herein, an interstice is formed between the end surface 45d of the base part 45, the end surface 45d whereof being located on the side of the base part 45 that is toward the lid member 28, and the fitting part 30 of the lid member 28, and, as depicted in FIG. 1, an interstice is also formed between each respective projection part 65 and the fitting part 30 of the lid member 28, whereupon the refrigerant 14 is received upon an entirety of a space within the tubular member 15, with the space within the tubular member 15 not being partitioned by the projection part 65 into a space that takes in the refrigerant 14 and a space that does not take in the refrigerant 14. It is thereby possible to make an effective use of the space within the tubular member 15 as the space that takes in the refrigerant 14.

As an instance thereof, when a pressure from the refrigerant 14, which flows within the tubular member 15, acts upon the pipe member 16, acting thereby as a rotation force that causes the pipe member thereof to rotate upon a circumference of the axis thereof, the rotation force that acts thereupon acts as a compressive force that compresses the plate part 67, from among each respective plate part 67 of each respective coupling part 66, which is located upon a side thereof that is in a direction of the action of the rotation force thereupon, upon the direction of the circumference of the pipe member 15. As a result, the rotation force is received by each respective plate part 67, and the pipe member 15 is prevented from rotating upon the axis thereof.

When assembling the expansion valve 10, the assembly thereof commences with inserting the pipe member 16, whereupon the valve mechanism 17 is pre-incorporated, within the tubular member 15, from the another end 15b thereof, such that the temperature sensor part 51 is located upon an upper side of the pipe member 16 thereby. In such a circumstance, as described herein, each respective plate part 67 of each respective coupling part 66 respectively extends along the direction of the axis of the tubular member 15, and thus, inserting each respective projection part 65 between the plate part 67 that corresponds thereto, and thereby guiding the pipe member 16 in a line with each respective projection part 65 thereupon, allows the pipe member 16 to be inserted within the tubular member 15 with ease. Put another way, each respective plate part 67 of each respective coupling part 66 further comprises a guide function, which respectively guides a movement of each respective projection part 65 when the pipe member 16 is being inserted within the tubular member 15. In addition, inserting each respective projection part 65 between each respective plate part 67 thereupon allows determining a positioning of the pipe member 16 within the tubular member 15 with ease. When inserting the pipe member 16 within the tubular member 15, the other end part 16b of the pipe member 16 is inserted within the high-pressure outflow aperture 20.

Thereafter, the lid member 28 is mounted upon the another end 15b of the tubular member 15. In such a circumstance, the end part 16a of the pipe member 16 is inserted within the high-pressure inflow aperture 36. The assembly of the expansion valve 10 is thereby completed.

According to the embodiment, as described herein, the pipe member 16, which regulates the conventional high-pressure flow path that channels the high-pressure refrigerant 14 from the condenser 12, is inserted within the tubular member 15, which regulates the conventional low-pressure flow path that channels the low-pressure refrigerant 14 from the evaporator 13, and is formed separately from the tubular member thereof, wherein the valve mechanism 17, which operates so as to adjust the flow quantity of the refrigerant 14 within the pipe member, is installed upon the pipe member thereof, the low-pressure inflow aperture 19, which is for taking in the refrigerant 14 that is sent from the evaporator 14 within the tubular member 15, and the high-pressure outflow aperture 20, which is for discharging the refrigerant 14 from the pipe member 16 to the evaporator 14, are formed upon the end partition 18 of the tubular member 15, and the low-pressure outflow aperture 35, which is for causing the refrigerant 14 to flow out from within the tubular member 15 to the gas compressor 11, and the high-pressure inflow aperture 36, which is for taking in the refrigerant 14 that is sent from the condenser 12 within the pipe member 16, which is inserted within the tubular member 15, are formed upon the lid member 28 that is mounted upon the another end 15b of the tubular member 15.

Thus, in attaching the valve mechanism 17 upon the pipe member 16 when manufacturing the expansion valve, the valve seat 53 and the valve body 52 are respectively positioned within the pipe member 16, which is the high-pressure flow path, the diaphragm 54 is positioned external to the pipe member 16, and inserting the pipe member 16 within the tubular member 15 in the state thereupon results in the diaphragm 54 being positioned within the tubular member 15, which is the low-pressure flow path. Put another way, it is sufficient for the pipe member 16, whereupon the valve mechanism 17 is installed, to be inserted within the tubular member 15, in order to incorporate the valve mechanism 17 within the expansion valve, such that the diaphragm 54 is reliably positioned within the low-pressure flow path, and the valve seat 53 and the valve body 52 are respectively reliably positioned within the high-pressure flow path.

As a result, it is not necessary to perform a high precision adjustment operation upon a relative location of the formation of the high-pressure flow path, the low-pressure flow path, and the housing aperture, upon a single block body, in accordance with the state of the valve mechanism, such as would be necessary in a conventional instance of forming the high-pressure flow path, the low-pressure path, and the housing aperture, respectively, by machining the single block body, in order to incorporate the valve mechanism within the expansion valve, such that the diaphragm is reliably positioned within the low-pressure flow path, and that the valve seat and the valve body are respectively reliably positioned within the high-pressure flow path.

Accordingly, a complexity that is invited by the formation operation involving such as the conventional process of adjusting, with a high precision, the relative location of the formation of the high-pressure flow path, the low-pressure path, and the housing aperture, upon the block body, in accordance with the state of the valve mechanism, is avoided, and it is thus possible to manufacture the expansion valve 10, comprising the low-pressure flow path that channels the low-pressure refrigerant 14 from the evaporator 13, and the high-pressure flow path that channels the high-pressure refrigerant 14 from the condenser 12, with greater simplicity than would be possible with the conventional approach thereupon.

In addition, as described herein, the pipe part 22, which is fitted upon the discharge aperture 21 of the evaporator 13, is formed upon the edge part 19a of the low-pressure inflow aperture 19, so as to protrude from the edge part in the direction external to the direction of the axis of the tubular member 15, and to encompass the low-pressure inflow aperture 19, and the another end part 16b, which is located upon the high-pressure outflow aperture 20 side of the pipe member 16, extends from within the tubular member 15, by way of the high-pressure outflow aperture 20, in the direction external to the direction of the axis thereof, and is fitted upon the intake aperture 27 of the evaporator 13, such that the pipe part 22 and the another end part 16b of the pipe member 16 are respectively fitted upon the discharge aperture 21 and the intake aperture 27 of the evaporator 13, and it is thereby possible to directly connect the expansion valve 10 to the evaporator 13, without employing a connecting pipe for the connection thereof, as an instance. As a result, it would definitely be possible to perform an operation of connecting the expansion valve 10 to the evaporator 13 more easily than the circumstance wherein the connecting pipe is employed in connecting the expansion valve 10 to the evaporator 13.

In addition, when the evaporator 13 and the expansion valve 10 are respectively positioned within a vehicle's engine housing, as an instance thereof, being able to connect the expansion valve 10 to the evaporator 13 without requiring the connecting pipe thereupon allows requiring a smaller space for the positioning of the expansion valve 10, whereupon the evaporator 13 is connected, within the vehicle's engine housing, than would be required conventionally. As a result, it would be possible to make an effective use of the space within the engine housing for another purpose.

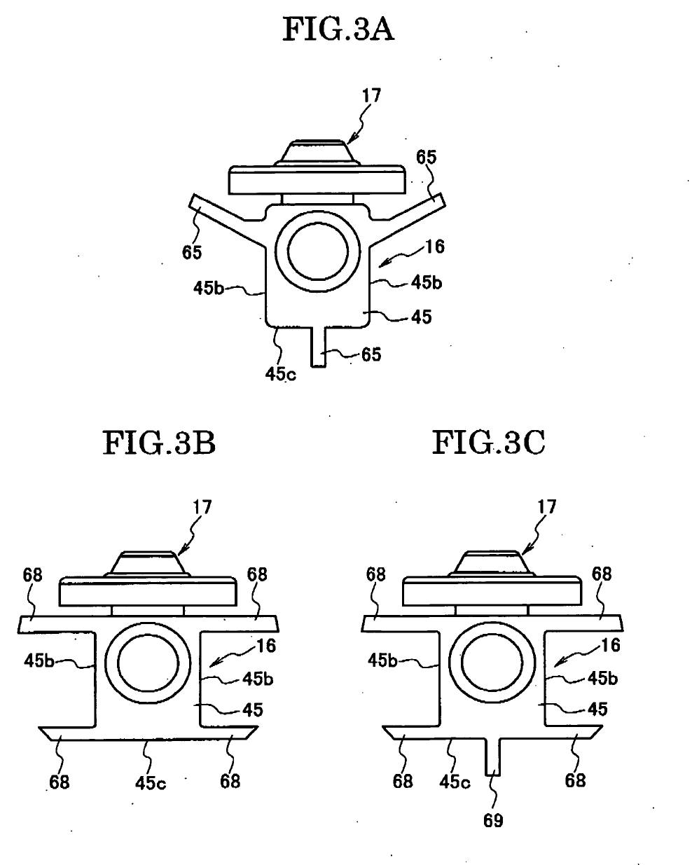

Furthermore, as described herein, the rotation prevention unit 64 is installed between the tubular member 15 and the pipe member 16, in order to prevent the pipe member 16 from rotating along the axis thereof, and it is possible thereby to reliably prevent the location of each respective end part 16a and 16b of the pipe member 16 from becoming misaligned, by way of the rotation of the pipe member 16 about the axis thereof, from a location that is appropriate for opening up externally to the tubular member 15 by way of the high-pressure outflow aperture 20 and the high-pressure inflow aperture 36, to another location thereof, respectively. It is thereby possible to reliably prevent a differential from arising, as a consequence of the location of each respective end part 16a and 16b of the pipe member 16 from becoming misaligned from the respective appropriate location thereof to another location thereof, with the inflow quantity of the refrigerant 14 upon the interior of the pipe member 16 and the outflow quantity of the refrigerant 14 outward from the pipe member 16.

Whereas, according to the embodiment, an instance has been depicted wherein each respective projection part 65 that is formed upon each respective lateral surface 45b of the base part 45 of the pipe member 16 protrudes respectively toward the internal peripheral surface 15c of the tubular member 15, laterally in the direction of the base part 45, it would instead be possible, as an instance thereof, to form each respective projection part 65 so as to protrude from each respective lateral surface 45b of the base part 45 toward the internal peripheral surface 15c of the tubular member 15 upwardly at an incline thereupon, such as is depicted in FIG. 3A.

In addition, whereas, according to the embodiment, an instance has been depicted wherein the projection part 65 is formed one at a time upon each respective lateral surface 45b of the base part 45, and furthermore, a single protrusion part 65 is formed upon the lower surface 45c of the base part 45, it would instead be possible, as an instance thereof, to form a pair of a projection part 68 upon each respective lateral surface 45b of the base part 45, which mutually protrude respectively in a parallel plane thereto from each respective lateral surface thereof, toward the internal peripheral surface 15c of the tubular member 15, so as to mutually maintain an interval between the pair of the projection part 68 in a vertical direction therewith, such as is depicted in FIG. 3B, and in addition, it would be possible to form a projection part 69, in addition to each respective projection part 68 that is depicted in FIG. 3B, upon the lower surface 45c of the base part 45, which protrudes in a downward direction from the lower surface thereof toward the internal peripheral surface 15c of the tubular member 15, such as is depicted in FIG. 3C.

When employing the embodiment depicted in FIG. 3A through FIG. 3C with the present invention, it would be possible to change, as appropriate, the location of the formation of each respective coupling part 66 upon the tubular member 15 to a location whereat each respective coupling part would be capable of coupling with each respective projection part 68 and 69, in accordance with the location of the formation of each respective projection part 68 and 69 upon the base part 45.

In addition, whereas, according to the embodiment, an instance has been depicted wherein each respective coupling part 66 comprises the pair of the plate part 67, which respectively protrudes from the internal peripheral surface 15c of the tubular member 15, and which mutually extends in a parallel plane along the direction of the axis of the tubular member 15, it would instead be possible, as an instance thereof, to configure the coupling part 65, which couples with each respective projection part 65, from among each respective projection part 68 thereof, which is formed upon each respective lateral surface 45b of the base part 45, with a protrusion member that is positioned either or above or below each respective projection part 65, which protrudes from the internal peripheral surface 15c of the tubular member 15 toward the interior of the tubular member 15, and which extends along the direction of the axis of the tubular member 15. In such a circumstance, when the rotation force of the periphery of the axis of the pipe member 16 acts thereupon, the rotation force acts, from the pipe member 16, by way of the protrusion part 65, as a compressive force that compresses the protrusion member, from among each respective protrusion member, which is located further in the direction of the rotation than the projection part 65, in the direction of the rotation, and thus, it would be possible to capture the rotation force thereupon by way of the protrusion member thereof.

Furthermore, whereas, according to the embodiment, an instance has been depicted wherein the projection part 65, which is formed respectively upon each respective lateral surface 45b and the lower surface 45c of the base part 45, protrudes from each respective lateral surface 45b and the lower surface 45c thereof toward the internal peripheral surface 15c of the tubular member 15 and forms a plate shape that extends along the lengthwise direction of the base part 45, it would instead be possible, as an instance thereof, to configure each respective projection part 65 from a plurality of the protrusion member, which protrudes respectively from each respective lateral surface 45b and the lower surface 45c thereof toward the internal peripheral surface 15c of the tubular member 15, and which is formed with an interstice mutually therebetween along the lengthwise direction of the base part 45 thereof.

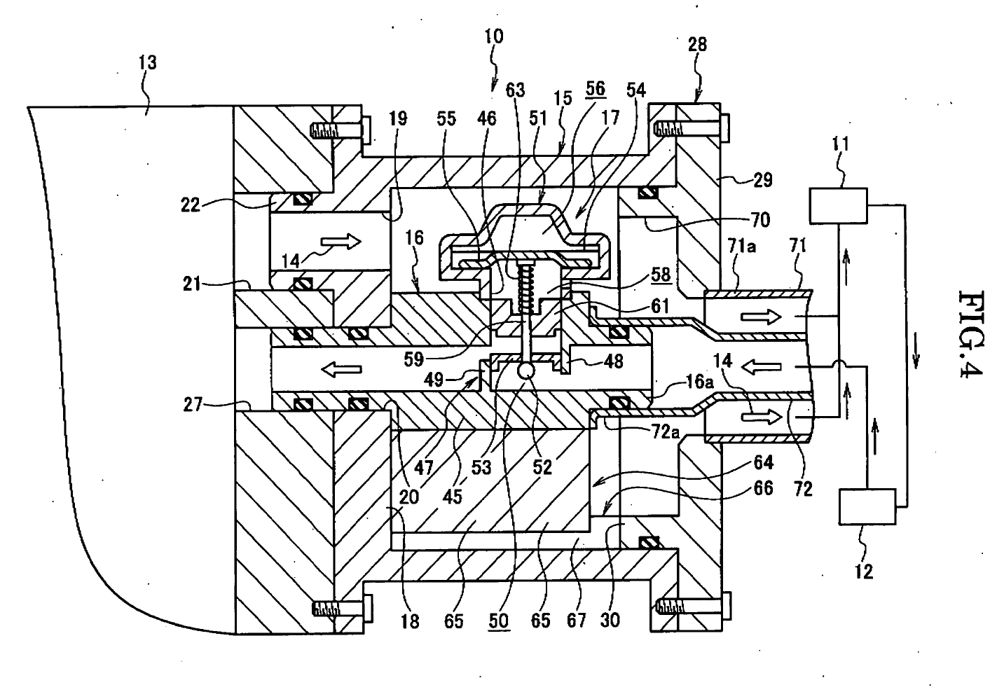

In addition, whereas, according to the embodiment, an instance has been depicted wherein the low-pressure outflow aperture 35 and the high-pressure inflow aperture 36 is formed respectively upon the fitting part 30 of the lid member 28, the connecting pipe 37 is connected upon the low-pressure outflow aperture 35 in order to mutually connect the gas compressor 11 and the expansion valve 10, and the connecting pipe 38 is connected upon the high-pressure inflow aperture 36 in order to mutually connect the condenser 12 and the expansion valve 10, it would instead be possible, as an instance thereof, to form an aperture opening 70, which is capable of receiving the end part 16a of the pipe member 16 with a degree of freedom, upon the fitting part 30 of the lid member 28, to tightly fit an end part 71a of a connecting pipe 71 in order to mutually connect the gas compressor 11 and the expansion valve 10 upon the aperture opening thereof, to insert a connecting pipe 72 in order to mutually connect the condenser 12 and the expansion valve 10, and to connect an end part 72a of the connecting pipe 72 with the end part 16a of the pipe member 16, such as is depicted in FIG. 4.

As a result, the refrigerant 14, which is guided from the condenser 12 upon the expansion valve 10, by way of the connecting pipe 72, flows directly from within the connecting pipe 72 within the pipe member 16, and, by way of the interior of the pipe member 16, in a manner similar to the description herein, flows within the evaporator 13, by way of the high-pressure outflow aperture 20 and the intake aperture 27. In addition, the refrigerant 14, which flows within the tubular member 15 from the evaporator 13, by way of the low-pressure inflow aperture 19, flows from within the tubular member 15, by way of an interval between an interior peripheral surface 70a of the aperture opening 70 and an exterior peripheral surface 72a of the connecting pipe 72, within the connecting pipe 71, and is guided, by way of the interior of the connecting pipe, upon the gas compressor 11.

In addition, whereas, according to the embodiment, an instance has been depicted wherein the rotation prevention unit 64, which prevents the pipe member 16 from rotating upon the axis thereof, comprises the plurality of the projection part 65 and the plurality of the coupling part 66, it would instead be possible to apply a rotation prevention unit, which is configured from a member other than each respective projection part 65 and each respective coupling part 66, to the prevent invention, if the rotation prevention unit thus configured is capable of preventing the rotation of the pipe member 16 upon the axis thereof.

Furthermore, whereas, according to the embodiment, an instance has been depicted wherein the base part 45 is formed in order to mount the valve mechanism 17 upon the pipe member 16, it would instead be possible to obviate the base part 45 thereupon. In such a circumstance, it would be possible to directly mount the valve mechanism 17 upon the pipe member 16.

In addition, whereas, according to the embodiment, an instance has been depicted wherein the low-pressure inflow aperture 19 and the high-pressure outflow aperture 20 is formed respectively upon the end partition 18 of the tubular member 15, and the low-pressure outflow aperture 35 and the high-pressure inflow aperture 36 is formed respectively upon the lid member 28, it would instead be possible to respectively form the low-pressure inflow aperture 19 and the high-pressure outflow aperture 20 upon the lid member 28, and to respectively form the low-pressure outflow aperture 35 and the high-pressure inflow aperture 36 upon the end partition 18 of the tubular member 15. In such a circumstance, the expansion valve 10 is positioned such that the lid member 28 is in opposition to the peripheral wall 13a of the evaporator 13.

Furthermore, whereas, according to the embodiment, an instance has been depicted wherein the displacement member, which displaces in accordance with the temperature of the refrigerant 14 that passes within the the tubular member 15, is configured with the diaphragm 54, it would instead be possible to apply a member other than the diaphragm 54 to the present invention, if the other member thus applied is capable of displacing in accordance with the temperature of the refrigerant 14 that passes within the the tubular member 15.

In addition, whereas, according to the embodiment, an instance has been depicted wherein the expansion valve 10 according to the present invention is employed in an air conditioning apparatus that is installed upon a vehicle, it would instead be possible to employ the expansion valve 10 according to the present invention in an air conditioning apparatus that is installed upon a site other than a vehicle.

### ADVANTAGEOUS EFFECTS OF INVENTION

As described herein, with regard to the expansion valve according to the present invention, a pipe member, which conventionally regulates a high-pressure flow path that channels a high-pressure refrigerant from a condenser, is inserted within a tubular member, which conventionally forms a low-pressure flow path that channels a low-pressure refrigerant from an evaporator, wherein the pipe member therein is formed separately from the tubular member, a valve mechanism, comprising a displacement member, which is positioned external to the pipe member, and which displaces in accordance with the temperature of the refrigerant that flows within the tubular member, a valve body, which is positioned within the pipe member, and which moves in accordance with the displacement of the displacement member, and a valve seat, which is positioned within the pipe member, and which receives the valve body in order to close the pipe member, is installed upon the pipe member, wherein a low pressure inflow aperture, which is for causing the refrigerant that is conveyed from the evaporator to flow within the tubular member, and a high pressure outflow aperture, which is for causing the refrigerant to flow out from the pipe member, which is inserted within the tubular member, and therefrom within the evaporator, are formed upon an end partition, which is formed upon one end of the tubular member, and a lid member, which is detachably attached upon another end of the tubular member, and a low-pressure outflow aperture, which is for causing the refrigerant to flow out from within the tubular member and within a gas compressor, and a high-pressure inflow aperture, which is for causing the refrigerant that is conveyed from the condenser to flow within the pipe member that is inserted in the tubular member, are formed upon another side thereof.

Accordingly, moving the valve body toward the valve seat, by way of the displacement of the displacement member in accordance with the temperature of the refrigerant that flows within the tubular member from the evaporator, by way of the low pressure inflow aperture, allows reducing an interstice between the valve body and the valve seat, that is, a degree of opening of the valve. As a result, a surface area within the pipe member whereupon the refrigerant is capable of flowing is reduced, the refrigerant that flows from the condenser within the pipe member, by way of the high pressure inflow aperture, expands, and it is possible to reduce a flow quantity of the refrigerant that flows from the pipe member within the evaporator by way of the high pressure outflow aperture, in a manner similar to a conventional technology thereof.

In addition, in incorporation the valve mechanism upon the pipe member when manufacturing the expansion valve, the valve seat and the valve body are respectively positioned within the pipe member, which is the high-pressure flow path, the diaphragm is positioned external to the pipe member, and inserting the pipe member within the tubular member in the state thereupon results in the diaphragm being positioned within the tubular member, which is the low-pressure flow path. Put another way, it is sufficient for the pipe member, whereupon the valve mechanism is installed, to be inserted within the tubular member, in order to incorporate the valve mechanism within the expansion valve, such that the diaphragm is reliably positioned within the low-pressure flow path, and the valve seat and the valve body are respectively reliably positioned within the high-pressure flow path.

As a result, it is not necessary to perform a high precision adjustment operation upon a relative location of the formation of the high-pressure flow path, the low-pressure flow path, and the housing aperture, upon a single block body, in accordance with the state of the valve mechanism, such as would be necessary in a conventional instance of forming the high-pressure flow path, the low-pressure path, and the housing aperture, respectively, by machining the single block body, in order to incorporate the valve mechanism within the expansion valve, such that the displacement member is reliably positioned within the low-pressure flow path, and that the valve seat and the valve body are respectively reliably positioned within the high-pressure flow path.

Accordingly, a complexity that is invited by the formation operation involving such as the conventional process of adjusting, with a high precision, the relative location of the formation of the high-pressure flow path, the low-pressure path, and the housing aperture, upon the block body, in accordance with the state of the valve mechanism, is avoided, and it is thus possible to manufacture the expansion valve, comprising the low-pressure flow path that channels the low-pressure refrigerant from the evaporator, and the high-pressure flow path that channels the high-pressure refrigerant from the condenser, with greater simplicity than would be possible with the conventional approach thereupon.

In addition, the pipe part, which is fitted upon the discharge aperture of the evaporator, is formed upon the edge part of the low-pressure inflow aperture, so as to protrude from the edge part in the direction external to the direction of the axis of the tubular member, and to encompass the low-pressure inflow aperture, and an end part, which is located upon the high-pressure outflow aperture side of the pipe member, extends from within the tubular member, by way of the high-pressure outflow aperture, in the direction external to the direction of the axis thereof, and is fitted upon the intake aperture of the evaporator, such that the pipe part and the end part of the pipe member are respectively fitted upon the discharge aperture and the intake aperture of the evaporator, and it is thereby possible to directly connect the expansion valve to the evaporator, without employing a connecting pipe for the connection thereof, as an instance. As a result, it would definitely be possible to perform an operation of connecting the expansion valve to the evaporator more easily than the circumstance wherein the connecting pipe is employed in connecting the expansion valve to the evaporator.

In addition, when the evaporator and the expansion valve are respectively positioned within a vehicle's engine housing, as an instance thereof, being able to connect the expansion valve to the evaporator without requiring the connecting pipe thereupon allows requiring a smaller space for the positioning of the expansion valve, whereupon the evaporator is connected, within the vehicle's engine housing, than would be required conventionally. As a result, it would be possible to make an effective use of the space within the engine housing for another purpose.

Furthermore, a rotation prevention unit is installed between the tubular member and the pipe member, in order to prevent the pipe member from rotating along an axis thereof, and it is possible thereby to reliably prevent the location of each respective end part of the pipe member from becoming misaligned, by way of the rotation of the pipe member about the axis thereof, from a location that is appropriate for opening up externally to the tubular member by way of the high-pressure outflow aperture and the high-pressure inflow aperture, to another location thereof, respectively. It is thereby possible to reliably prevent a differential from arising, as a consequence of the location of each respective end part of the pipe member from becoming misaligned from the respective appropriate location thereof to another location thereof, with the flow quantity of the refrigerant upon the interior of the pipe member and the flow quantity of, the refrigerant outward from the pipe member.

Furthermore, the rotation prevention unit comprises a plurality of projection parts, which are formed upon an external peripheral surface of the pipe member, with a prescribed interstice being mutually interspersed therebetween, and which protrude from the external circumference surface thereof toward an internal peripheral surface of the tubular member, and a plurality of coupling parts, which are formed upon the internal peripheral surface of the tubular member, and which couple, at a minimum, with each respective projection part either in an upward direction or in a downward direction thereupon, respectively, in a state of the pipe member being inserted within the tubular member, and thus, as an instance thereof, when a pressure either from the high-pressure refrigerant, which flows within the pipe member, or from the low-pressure refrigerant, which flows within the tubular member, acts upon the pipe member as a rotation force that causes the pipe member thereof to rotate upon a circumference of the axis thereof, the rotation force that acts thereupon acts as a compressive force that compresses the coupling part, from among the coupling part that is located upon a side thereof that is in a direction of the action of the rotation force thereupon, upon the direction of the circumference of the tubular member, from the pipe member, by way of each respective protrusion part thereupon. As a result, the rotation force is received by each respective coupling part thereupon, and it is thus possible to reliably prevent the pipe member from rotating, by way of the rotation force thereupon, upon a periphery of the axis thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1-6. (canceled)

7. An expansion valve configured to control an inflow quantity of a coolant which is sent from a condenser configured to liquefy the coolant to an evaporator, in accordance with a temperature of the coolant which is sent from an evaporator configured to gasify the coolant in a liquid state toward a gas compressor configured to compress the coolant that has been gasified by the evaporator,
the expansion valve comprising:
a tubular member configured to receive the coolant having a low pressure which is sent from the evaporator;
a pipe member configured to be inserted within the tubular member, and to receive the coolant having a high pressure which is sent from the condenser; and
a valve mechanism configured to be installed upon the pipe member, and to operate so as to adjust a flow quantity of the coolant within the pipe member; wherein:
the valve mechanism is configured to further comprise:
a displacement member configured to be positioned externally to the pipe member, and to displace according to the temperature of the coolant that passes within the tubular member;
a valve body configured to be positioned within the pipe member, and to move in accordance with the displacement of the displacement member; and
a valve seat configured to be positioned within the pipe member, and to receive the valve body so as to close an interior of the pipe member;
wherein the tubular member is provided at one end thereof with an end wall configured to close the one end thereof;
wherein the tubular member is provided at the other end with a lid member to close the other end thereof;
wherein one of the end wall and the lid member is provided with a low-pressure inflow aperture configured to inflow the coolant that is sent from the evaporator into the tubular member, and a high-pressure outflow aperture configured to outflow the coolant from the pipe member which is inserted within the tubular member to the evaporator, and
wherein the other of the end wall and the lid member is provided with a low-pressure outflow aperture configured to outflow the coolant within the tubular member to the gas compressor, and a high-pressure inflow aperture configured to inflow the coolant that is sent from the evaporator to the pipe member which is inserted within the tubular member.

8. The expansion valve according to claim 7, wherein:
a pipe part is formed upon an edge part of the low-pressure inflow aperture, the pipe part being configured to protrude from the edge part thereof and to encompass the low-pressure inflow aperture thereof;
wherein:
an end part of the pipe member that is located upon a side of the pipe member whereupon the high-pressure outflow aperture is formed extends from within the tubular member, by way of the high-pressure outflow aperture, external to a direction along an axis thereof, and is fitted upon an intake aperture of the evaporator.

9. The expansion valve according to claim 7, wherein:
a rotation prevention unit configured to prevent the pipe member from rotating upon a circumference of an axis thereof is installed between the tubular member and the pipe member.

10. The expansion valve according to claim 8, wherein:
a rotation prevention unit configured to prevent the pipe member from rotating upon the circumference of the axis thereof is installed between the tubular member and the pipe member.

11. The expansion valve according to claim do wherein:
the rotation prevention unit is configured to further comprise:
a plurality of protrusion units configured to be formed upon an exterior periphery surface of the pipe member, with a prescribed interstice spaced therebetween, in a direction of the circumference of the pipe member, and to protrude from the exterior periphery surface thereof toward an interior periphery surface of the tubular member; and
a plurality of coupling parts configured to be formed upon the interior periphery surface of the tubular member, and to couple upon each respective protrusion part either in an upward direction or in a downward direction, respectively, at a minimum, in a state wherein the pipe member is inserted within the tubular member.

12. The expansion valve according to claim 10, wherein:
the rotation prevention unit is configured to further comprise:
a plurality of protrusion units configured to be formed upon an exterior periphery surface of the pipe member, with a prescribed interstice spaced therebetween, in a direction of the circumference of the pipe member, and to protrude from the exterior periphery surface thereof toward an interior periphery surface of the tubular member; and
a plurality of coupling parts configured to be formed upon the interior periphery surface of the tubular member, and to couple upon each respective protrusion part either in an upward direction or in a downward direction, respectively, at a minimum, in a state wherein the pipe member is inserted within the tubular member.
